(19) United States
(12) Patent Application Publication
(10) Pub. No.: US 2025/0044843 A1
(43) Pub. Date: Feb. 6, 2025

(54) HYBRID OF STATICALLY AND DYNAMICALLY DEFINED MAXIMUM SUPPORTED AMBIENT TEMPERATURE IN AN INFORMATION HANDLING SYSTEM

(71) Applicant: DELL PRODUCTS L.P., Round Rock, TX (US)

(72) Inventors: Doug Messick, Austin, TX (US); Nadia Henry, Georgetown, TX (US); Jonathan Brown, Leander, TX (US); Carlos Henry, Georgetown, TX (US); Yugesh Boddu, Bangalore (IN)

(21) Appl. No.: 18/474,958

(22) Filed: Sep. 26, 2023

(30) Foreign Application Priority Data
Aug. 2, 2023 (IN) 202311052064

(51) Int. Cl. G06F 1/20

(52) U.S. Cl. CPC G06F 1/206

(57) ABSTRACT

An information handling system has a chassis having an embedded controller (EC) and a plurality of sleds, each having a BMC. Each BMC 1) determines a configuration of the sled, 2) matches the configuration to an entry of sled thermal characteristics table in the EC, 3) determines whether a maximum ambient temperature field has a first maximum ambient temperature value or an indication to calculate another maximum ambient temperature value, 4) when the maximum ambient temperature field has the first maximum ambient temperature value, ascribe the first maximum ambient temperature value to the operation of the sled, and, 5) when the maximum ambient temperature field has the indication, to a) receive an available airflow value from the EC, b) determine a second maximum ambient temperature value based upon the available airflow, and c) ascribe the second maximum ambient temperature value to the operation of the sled.

### FIELD OF THE DISCLOSURE

This disclosure generally relates to information handling systems, and more particularly relates to providing a hybrid of statically and dynamically defined maximum supported ambient temperature in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system has a chassis having an embedded controller (EC) and a plurality of sleds, each having a BMC. Each BMC 1) determines a configuration of the sled, 2) matches the configuration to an entry of sled thermal characteristics table in the EC, 3) determines whether a maximum ambient temperature field has a first maximum ambient temperature value or an indication to calculate another maximum ambient temperature value, 4) when the maximum ambient temperature field has the first maximum ambient temperature value, ascribe the first maximum ambient temperature value to the operation of the sled, and, 5) when the maximum ambient temperature field has the indication, to a) receive an available airflow value from the EC, b) determine a second maximum ambient temperature value based upon the available airflow, and c) ascribe the second maximum ambient temperature value to the operation of the sled.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a general information handling system according to an embodiment of the present disclosure;

FIG. 2 is a diagram of an information handling system with multiple sleds according to an embodiment of the disclosure;

FIG. 3 is a block diagram of the information handling system according to an embodiment of the disclosure;

FIG. 4 is a block diagram of a machine learning system according to an embodiment of the disclosure;

FIG. 5 is a flow diagram of a method for determining a maximum airflow for each sled of an information handling system according to an embodiment of the disclosure;

FIG. 6 is a flow diagram of a method for determining an airflow equation for airflow in each sled of an information handling system according to an embodiment of the current disclosure; and

FIG. 7 is a flowchart illustrating a method for a hybrid of statically and dynamically defined maximum supported ambient temperature in an information handling system according to an embodiment of the current disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

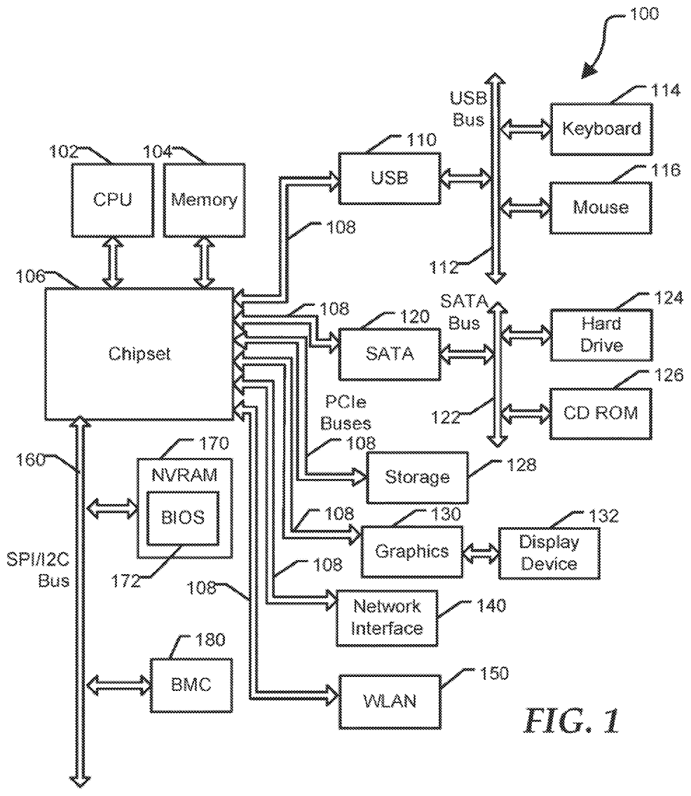

FIG. 1 illustrates a general information handling system 100. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various other I/O devices, such as a keyboard, a mouse, and a video display. The information handling system may also include one or more busses operable to transmit communications between the various hardware components.

Information handling system 100 includes a processor 102, a memory 104, a chipset 106, one or more PCIe buses 108, a universal serial bus (USB) controller 110, a USB bus 112, a keyboard device controller 114, a mouse device controller 116, a SATA bus controller 120, a SATA bus 122, a hard drive device controller 124, a compact disk read only memory (CD ROM) device controller 126, a storage 128, a graphics device controller 130, a display device 132, a network interface controller (NIC) 140, a wireless local area network (WLAN) or wireless wide area network (WWAN) controller 150, a serial peripheral interface (SPI) bus 160, a NVRAM 170 for storing BIOS 172, and a baseboard management controller (BMC) 180.

In an example, chipset 106 may be directly connected to an individual end point via a PCIe root port within the chipset and a point-to-point topology as shown in FIG. 1. BMC 180 can be referred to as a service processor or embedded controller (EC). Capabilities and functions provided by BMC 180 can vary considerably based on the type of information handling system. For example, the term baseboard management system is often used to describe an embedded processor included at a server, while an embedded controller is more likely to be found in a consumer-level device. As disclosed herein, BMC 180 represents a processing device different from CPU 102, which provides various management functions for information handling system 100. For example, an embedded controller may be responsible for power management, cooling management, and the like. An embedded controller included at a data storage system can be referred to as a storage enclosure processor.

Information handling system 100 can include additional processors that are configured to provide localized or specific control functions, such as a battery management controller. Bus 160 can include one or more busses, including a SPI bus, an I2C bus, a system management bus (SMBUS), a power management bus (PMBUS), and the like. BMC 180 can be configured to provide out-of-band access to devices at information handling system 100. As used herein, out-of-band access herein refers to operations performed prior to execution of BIOS 172 by processor 102 to initialize operation of information handling system 100.

BIOS 172 can be referred to as a firmware image, and the term BIOS is herein used interchangeably with the term firmware image, or simply firmware. BIOS 172 includes instructions executable by CPU 102 to initialize and test the hardware components of information handling system 100, and to load a boot loader or an operating system (OS) from a mass storage device. BIOS 172 additionally provides an abstraction layer for the hardware, such as a consistent way for application programs and operating systems to interact with the keyboard, display, and other input/output devices. When power is first applied to information handling system 100, the system begins a sequence of initialization procedures. During the initialization sequence, also referred to as a boot sequence, components of information handling system 100 are configured and enabled for operation, and device drivers can be installed. Device drivers provide an interface through which other components of the information handling system 100 can communicate with a corresponding device.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple CPUs and redundant bus controllers. One or more components can be integrated together. For example, portions of chipset 106 can be integrated within CPU 102. Additional components of information handling system 100 can include one or more storage devices that can store machine-executable code, one or more communications ports for communicating with external devices, and various input and output (I/O) devices, such as a keyboard, a mouse, and a video display. An example of information handling system 100 includes a multi-tenant chassis system where groups of tenants (users) share a common chassis, and each of the tenants has a unique set of resources assigned to them. The resources can include blade servers of the chassis, input/output (I/O) modules, Peripheral Component Interconnect-Express (PCIe) cards, storage controllers, and the like.

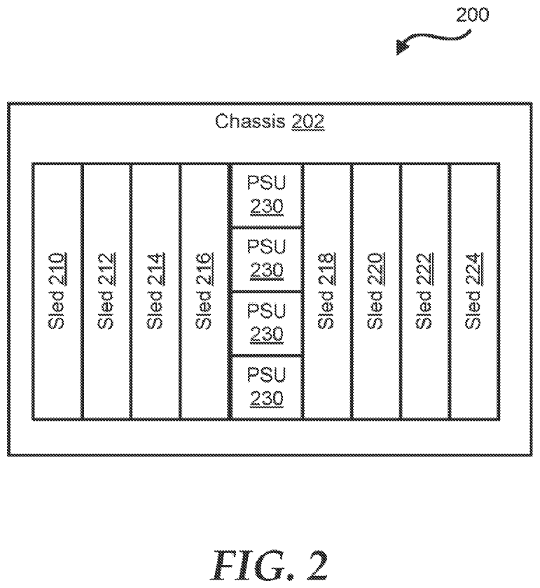

In an example, information handling system 100 may be any suitable device including, but not limited to, sleds 202, 204, 206, 208, 210, 212, 214, and 216 of FIG. 2. Information handling system 100 can include a set of instructions that can be executed to cause the information handling system to perform any one or more of the methods or computer-based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at information handling system 100, and/or within the processor 102 during execution by the information handling system 100. The system memory 104 and the processor 102 also may include computer-readable media.

FIG. 2 illustrates an information handling system 200 according to at least one embodiment of the disclosure. Information handling system 200 includes a chassis 202, multiple sleds 210, 212, 214, 216, 218, 220, 222, and 224 (sleds 210-224), and multiple power supply units (PSUs) 230. Sleds 210-224 may be any suitable component within a slot of chassis 202. For example, a sled may be a single wide sled, a double wide sled, a blank sled, or the like. PSUs 230 may provide power to each of sleds 210-224. In an example, information handling system 200 may include additional components over those shown in FIG. 2 without varying from the scope of this disclosure.

An amount of cooling airflow for each of sleds 210-224 may be based on an amount of power consumed by processors within the sled. For example, one of sleds 210-224 may include multiple processors rated between two hundred and three hundred Watts, which may need more cooling airflow than another sled that only includes fifty to one-hundred Watts processors. In an example, sleds 210-224 may include different airflow impedances. In certain examples, an airflow impedance of a particular sled of sleds 210-224 may be based on any suitable number of factors including, but not limited to, the components included within the sled. For example, sled 210 may include a particular number of hard drives, and sled 212 may include lower number of hard drives. In this example, sled 210 may have a higher airflow impedance as compared to sled 212 based on the higher number of hard drives in sled 210 blocking a larger amount of airflow as compared to sled 212. Sled 210 may receive a lesser amount of airflow based both on the airflow impedance of sled 210 and the airflow impedance of the adjacent sled 212.

In certain examples, thermal design power or point (TDP) may be a maximum amount of heat generated by CPUs and DIMMs that a cooling system is designed to dissipate under any workload. In an example, a maximum TDP may be defined based on a worst case mixing of sled impedances. A worst case mixing of sled impedance may be any differences in airflow impedances including, but not limited to, sled 210 having a high-impedance and remaining sleds 212-224 having a low-impedance. In a particular embodiment, the TDP of sleds 210-224 in chassis 202 is set for the worst-case impedance levels, without the actual chassis or sled configurations being determined. This embodiment may hereinafter be referred to as the static definition of the maximum supported ambient temperature in information handling system 200 based upon worst case sled impedances, as described above.

In another embodiment, the maximum airflow in cubic feet per minute (CFM) available to the sleds in a chassis is determined based upon the configuration of the sleds in the chassis. This embodiment may hereinafter be referred to as the dynamic definition of the maximum airflow available to each of the sleds, as described further below. In a particular case of this embodiment, once a required airflow is determined, the maximum operating temperature that can be maintained in each of the sleds with the dynamically determined airflow is determined by the each of the sleds and is set as the respective sleds' maximum operating temperature, as described further below. In another embodiment, a hybrid is provided of the static definition of sled impedances (worst case mixing), and the dynamic definition of the maximum airflow available to each of the sleds and the resulting selection of the maximum ambient temperature in each of the sleds, as described further below.

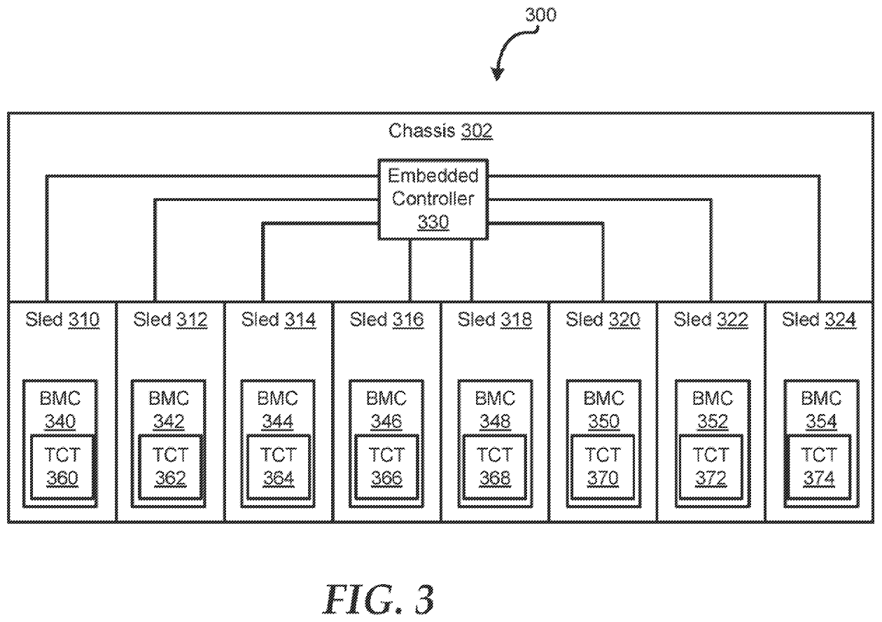

FIG. 3 illustrates a portion of an information handling system 300 including a chassis 302, multiple sleds 310, 312, 314, 316, 318, 320, 322, and 324 (sleds 310-324), and an embedded controller 330 according to at least one embodiment of the disclosure. Each sled 310-324 may communicate with embedded controller 300. Each of sleds 310-324 includes a respective baseboard management controller (BMC) 340, 342, 344, 346, 348, 350, 352, and 354 (BMCs 340-352), and respective thermal control tables 360, 362, 364, 366, 368, 370, 372, and 374. In an example, sleds 310-324 may include any additional hardware devices including, but not limited to, a CPU, one or more dual inline memory modules (DIMMs), network interface cards (NICs), hard disk drives (HDDs), and solid-state drives (SSDs). In certain examples, BMC may be a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like In an example, each BMC 340-354 may store any suitable data within a respective memory of the BMC including, but not limited to, respective TCT 360-374. In certain examples, information handling system 300 may include additional components over those shown in FIG. 3 without varying from the scope of this disclosure.

In information handling system 300, an individual may purchase a sled, such as sled 310, with specific components. For example, the components of sled 310 may include, but is not limited to, CPUs with certain power capacities, and a particular number of hard disk drives (HDDs) in the backplane of the sled. The power capacities of the CPUs may be 275 W, 300 W, or the like. The number of HDDs may be two, four, eight, or the like. In an example, at the point of sale for sled 310, the individual may be notified that the configuration of the sled requires a homogenous population of sleds in chassis 302 so that sleds 310-324 may run at full performance. The requirement for a homogenous population of sleds in chassis 302 may be based on any suitable characteristics of the sled including, but not limited to, the power usage of the CPUs, and the number of HDDs in the sled. For example, CPUs with 275 W power usage may require airflow of 55 cubic feet per minute (CFM) for proper cooling, and CPUs with 300 W power usage may need airflow of 56 CFM for propose cooling. In these examples, chassis 302 may only be able to provide these levels of airflow when the chassis has a homogenous population of airflow impedance among sleds 310-324. During the point of sale, the individual may be notified of configuration requirements for chassis 302 to enable sleds 310-324 to optimally perform.

In an example of the dynamic definition of the maximum supported ambient temperature, after the point of sale, the individual may insert a new sled 310 into chassis 302, or a new individual may own or operate chassis 302. In this example, EC 330 and BMCs 340-354 may communicate to determine the airflow available to each sled 310-324. Each BMC 340-354 may perform one or more operations to determine whether the available airflow is sufficient for the respective sled 340-354. For example, each BMC 340-354 may utilize the information associated with the available airflow and data within respective TCT 360-374 to determine if the available airflow meets the needs of respective sled 340-354. In an example, EC 330 may determine a restriction matrix for chassis 302 that represents an actual population of the chassis and not a worst-case scenario of sled populations. The operations of EC 330 and BMCs 340-354 may improve information handling system 300 by warning an individual if an available airflow is insufficient for one or more sleds 310-324. This is an improvement over previous information handling system, which may throttle CPUs in one or more sleds to prevent overheating of the sleds without the individual knowing why the throttling was performed.

In information handling system 300, any BMC 340-354 may request a boot operation for the corresponding sled 340-354, which in turn may initiate one or more operations in EC 330 and all BMCs. For brevity and clarity, operations herein will be described with respect to BMC 340 of sled 310 and EC 330, but may be performed by any BMC within chassis 302. For example, BMC 340 may request a boot operation for sled or server 310. Based on the boot operation request, BMC 340 may collect configuration information for sled 310 from any suitable source. In an example, the source of the configuration information may include, but is not limited to BMC 340 polling all components within sled 310 to determine characteristics for the components, BMC retrieving system inventory data from any suitable memory, and BMC retrieving data from TCT 360. Based on the configuration information for sled 310, BMC 340 may determine an airflow impedance for the sled based on determined platform airflow characterizations in the system inventory data. For example, during POST, BMC 340 may match the system inventory of components in sled 310 to a characterized impedance level table to determine the relative sled impedance. BMC 340 may provide a power allocation request and the airflow impedance for sled 310 to EC 330. In an example, the power allocation request may include a request to boot sled 310 to an operating system.

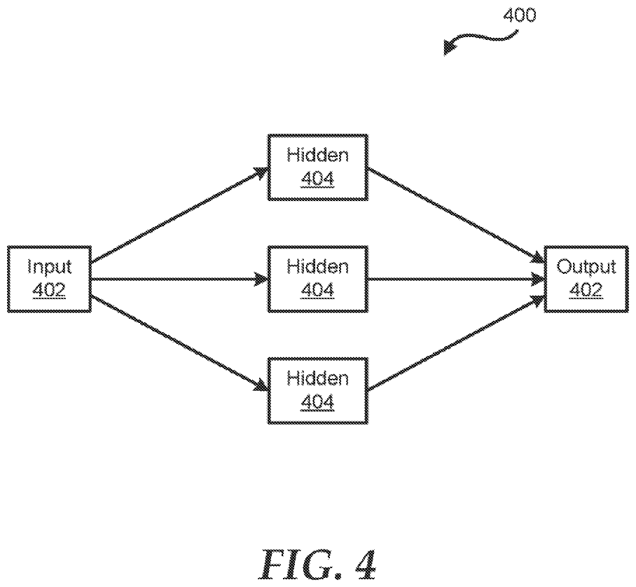

In response to receiving the power allocation request and the airflow impedance of sled 310, EC 330 may perform one or more suitable operations to calculate a maximum airflow for each sled or slot 310-324. EC 330 may communicate with all BMCs 340-354 to retrieve the airflow impedance for respective sleds 310-324. In certain examples, EC 330 may utilize the received airflow impedance in a machine learning system, such as machine learning system 400 of FIG. 4, to calculate the maximum airflow available to each sled 310-324.

FIG. 4 illustrates a machine learning system 400 according to at least one embodiment of the disclosure. Machine learning system 400 includes an input layer 402, one or more hidden layers 404, and an output layer 406. Input layer 402 may receive any suitable data associated with the airflow impedances of sled 310-324 and provide associated relative impedances for the sleds to hidden layers 404. In an example, airflow impedance may be a primary sled attribute that is utilized as an input data to input layer 402 of machine learning system 400. Hidden layers 404 may perform one or more operations on the input data, such as the relative impedances of sleds 310-324, and determine a different airflow equation for each of the sleds. The airflow equations for sleds 310-324 may be provided by output layer 406.

During training of machine learning system 400, a design-of-experiment (DOE) test plan may be utilized. In the DOE approach, each sled 310-324 may be provided with one of a set of relative impedances. For example, the relative impedances may be any suitable value including, but not limited to, 0, 1, 2, 3, and 4. In this example, a slot with a blank inserted as the sled may have a relative impedance of 4 or any corresponding highest impedance value. In an example, the lowest value for the relative impedances may represent the highest airflow impedance without varying from the scope of the disclosure.

In the training mode of machine learning system 400, any suitable number of DOEs may be generated and each DOE may include a different arrangement of relative impedances for sleds 310-324 as data for input layer 402. Hidden layers 404 may perform one or more operations to calculate an airflow equation for a particular sled, such as sled 310. In an example, the airflow equation for the particular sled may be provided by output layer 406. In an example, the training of hidden layers 404 may be performed in any suitable manner including, but not limited to, supervised learning, unsupervised learning, reinforcement learning, and self-learning. For example, if hidden layers 404 are trained via supervised learning, an individual may provide measured airflow data for each sled 310-324 while the relative impedances of the sleds are in each configuration of the DOEs. In this example, hidden layers 404 may utilize the receive airflow data to determine an airflow equation for each sled. In an example, any machine learning model may be utilized for determining the airflow equations including, but not limited to, a linear regression model.

During execution of machine learning system 400, input layer 402 may receive the impedances of sleds 310-324 and provide the impedances to hidden layers 404 in any suitable manner. For example, input layer 402 may convert the impedances into relative impedance values, may provide the impedance values as received from BMCs 340-354, or the like. Hidden layers 404 may then apply the received impedance levels for sleds 310-324 to the training data, which may provide an airflow equation for sled 310. The airflow equation for sled 310 may be provided to EC 330 via output layer 406. Machine learning system 400 may then perform the same operations to determine airflow equations for each sled 310-324 of chassis 302, and these equations may be provided by output layer 406.

In an example, the airflow equations may be any suitable equation including, but not limited to, linear regression equations. An exemplary linear regression equation for sled 310 is as follows:

$$Sled 310 CFM = - 16.7 * Sled 310 + 3. * Sled 312 + 2. * Sled 314 + 1.8 * Sled 316 + 0.5 * Sled 318 + 0.4 * Sled 320 + 0.4 * Sled 322 + 0.1 * Sled 324 + 81.5 .$$

In this exemplary linear regression equation, Sled 310, Sled 312, Sled 314, Sled 316, Sled 318, Sled 320, Sled 322, and Sled 324 are the relative impedances level of the corresponding sled. As illustrated in the equation above, a weight of the relative impedances decreases as a distance of a sled increases from sled 310.

Referring back to FIG. 3, EC 330 may utilize the airflow equations to determine a maximum airflow, in CFM, for each sled 310-324. EC 330 may then provide the maximum airflow for each sled 310-324 to the respective BMC 340-354.

In response to receiving the maximum airflow for sled 310, BMC 340 perform one or more operations to determine whether the available airflow is sufficient. For example, BMC 340 may compare the received maximum airflow to data in TCT 360. In an example, TCT 360 may include or define a minimum airflow in CFMs need per CPU TDP of sled 310. If the maximum airflow value received from EC 330 is greater than the minimum airflow value in TCT 360, BMC 340 may determine that the available airflow is sufficient and may the components of sled 310 to perform normal operations. If the maximum airflow value received from EC 330 is less than the minimum airflow value in TCT 360, BMC 340 may determine that the guaranteed maximum available airflow is insufficient.

In response to the received maximum airflow value being less than the airflow value in TCT 360, BMC 340 may perform one or more operations to prevent components in sled 310 from overheating and to provide warnings to an individual associated with chassis 302. In an example, BMC 340 may provide thermal control limits on the components of sled 310. For example, BMC 340 may throttle CPUs within sled 310 to prevent overheating. In an example, BMC 340 also may provide warnings to an individual associated with the sled. For example, BMC 340 may provide a notification message indicating that sled 310 has power limits to prevent overheating. The message may be any suitable type of message including, but not limited to, an audio message and a visual message.

In an example, any BMC 340-354 and EC 330 may provide real-time airflow of respective sleds 310-324 to an individual associated with the sleds. Similarly, EC 330 may provide real-time airflow for chassis 302 to the individual. In certain examples, the data generated for maximum available airflow to each sled 310-324 may be provided during a point of sale to help individuals size a data center airflow capacity for chassis 302.

As stated above, EC 330 and BMCs 340-354 perform any suitable operations to determine if a maximum airflow available to each of sleds 310-324 may provide enough cooling for the sled, but not a best cooling configuration. In certain examples, EC 330 may perform the operations described above with respect to BMC 340 without varying from the scope of this disclosure. In an example, characterizations of chassis 300 may be performed at any suitable fan speed, such as fan speeds less than 100% PWM. In this example, the generated airflow equations to predict sled slot airflow may be developed as a function of system fan speeds.

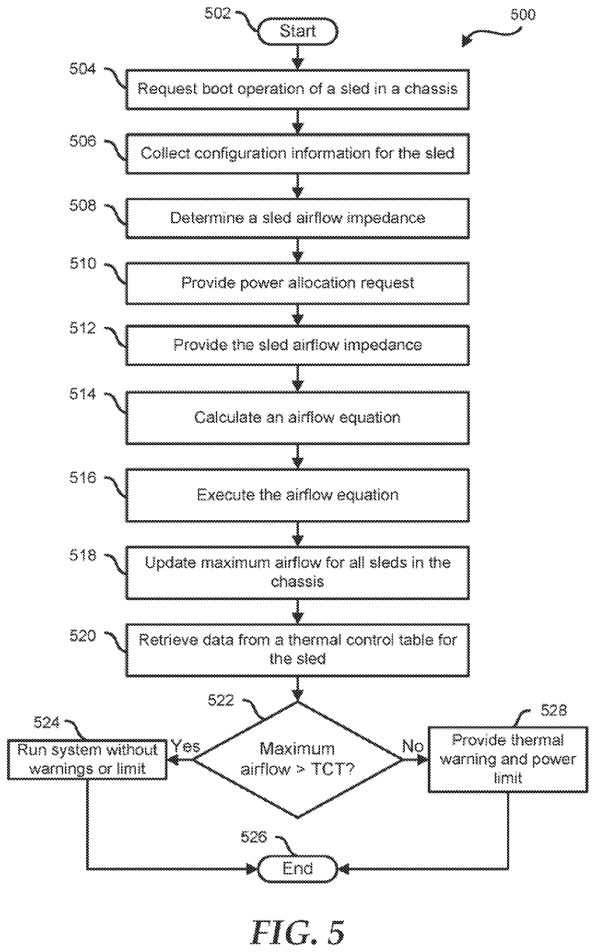

FIG. 5 is a flow diagram of a method 500 for determining a maximum airflow for each sled of an information handling system according to at least one embodiment of the disclosure, starting at block 502. It will be readily appreciated that not every method step set forth in this flow diagram is always necessary, and that certain steps of the methods may be combined, performed simultaneously, in a different order, or perhaps omitted, without varying from the scope of the disclosure. FIG. 5 may be employed in whole, or in part, by information handling system 100 depicted in FIG. 1, information handling system 300 depicted in FIG. 3, or any other type of system, controller, device, module, processor, or any combination thereof, operable to employ all, or portions of, the method of FIG. 5.

At block 504, a boot operation of a sled is requested In an example, a BMC of a sled may request the boot operation. In certain examples, the sled may be any suitable sled within a chassis of the information handling system. For example, the sled maybe a sled that is newly added to the chassis. At block 506, configuration information for the sled is collected. In an example, the source of the configuration information may include, but is not limited to, the BMC polling all components within sled to determine characteristics for the components, the BMC retrieving system inventory data from any suitable memory, and BMC retrieving data from a TCT. At block 508, a sled airflow impedance is determined. In an example, the BMC may utilize the configuration information for the sled to determine an airflow impedance for the sled based on determined platform airflow characterizations in the system inventory data. For example, during POST, the BMC may match the system inventory of components in the sled to a characterized impedance level table to determine the relative sled impedance. At block 510, a power allocation request is provided.

At block 512, the sled airflow impedance is provided. In an example, the BMC may provide the power allocated to an EC of the chassis along with the relative sled impedance. At block 514, an airflow equation is calculated. In an example, the airflow equation may be calculated by any suitable manner including, but not limited to, a machine learning system. The airflow equation may be any suitable equation including, but not limited to, a linear regression equation. At block 516, the airflow equation is executed. In an example, the execution of the airflow equation made calculate a maximum airflow available for a sled. At block 518, a maximum airflow is updated for all sleds in the chassis. At block 520, data from a TCT is retrieved for the sled. In an example, the data may include a minimum amount of airflow to cool the components of the sled.

At block 522, a determination is made whether the maximum airflow is greater than the TCT. If the maximum airflow is greater than the TCT, the system is run without warnings or limit at block 524, and the flow ends at block 526. If the maximum airflow is less than the TCT, thermal warnings and power limits are provided at block 528, and the flow ends at block 526. For example, the BMC may provide a notification message indicating that the sled has power limits to prevent overheating. The message may be any suitable type of message including, but not limited to, an audio message and a visual message.

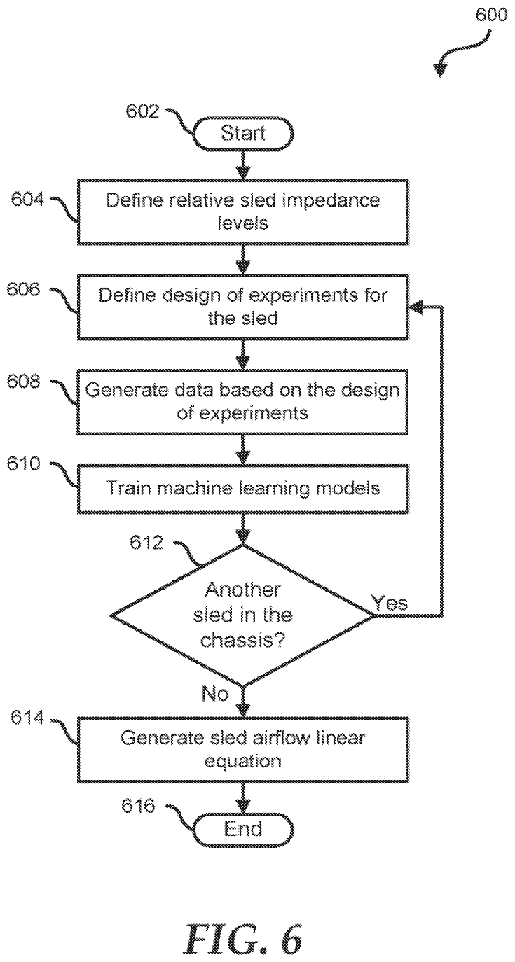

FIG. 6 is a flow diagram of a method 600 for determining an airflow equation for airflow in each sled of an information handling system according to at least one embodiment of the current disclosure, starting at block 602. It will be readily appreciated that not every method step set forth in this flow diagram is always necessary, and that certain steps of the methods may be combined, performed simultaneously, in a different order, or perhaps omitted, without varying from the scope of the disclosure FIG. 6 may be employed in whole, or in part, by information handling system 100 depicted in FIG. 1, information handling system 200 depicted in FIG. 2, or any other type of system, controller, device, module, processor, or any combination thereof, operable to employ all, or portions of, the method of FIG. 6.

At block 604, relative sled impedance levels are defined. In an example, each sled may be provided with one of a set of relative impedances. For example, the relative impedances may be any suitable value including, but not limited to, 0, 1, 2, 3, and 4. In an example, the relative sled impedance levels may be determined by BMCs associated with the sleds of a chassis. At block 606, designs of experiments (DOEs) are defined for the sled. At block 608, data is generated based on the experiments. In an example, the generated data may be utilized to train a machine learning system.

At block 610, machine learning models are trained. In the training mode of machine learning system, any suitable number of DOEs may be generated and each DOE may include a different arrangement of relative impedances for each sled in a chassis. In an example, the training may be performed in any suitable manner including, but not limited to, supervised learning, unsupervised learning, reinforcement learning, and self-learning In certain examples, the training may be performed on a sled-by-sled basis. At block 612, a determination is made whether another sled is in the chassis. If another sled is in the chassis, the flow continues as described above at block 606. If another sled is not located in the chassis, a sled airflow equation is generated at block 614, and the flow ends at block 616.

Returning to FIG. 3, in a particular case of the dynamic definition of the maximum airflow available to each of sleds 310-324, each sled further determines a maximum operating temperature given the available airflow as described above. Each of BMCs 340-354 includes entries in their respective TCTs 360-374 that correlate the airflow needed to maintain various ambient temperatures given the number of installed CPUs and DIMMs. For example, TCT 360 may include an entry that defines that the airflow necessary to maintain 25 C operation is 25-37 CFM, to maintain 30 C operation is 38-48 CFM, and to maintain 35 C operation is 49-255 CFM. Then when BMCs 340-354 receive their associated available airflows, as described above, the BMCs each compare the received airflows to the airflows required to maintain the various temperatures, and select the maximum ambient temperature available for their respective sleds 210-224. Continuing the above example, BMC 360 may receive an available airflow to sled 210 of 53 CFM. BMC 360 determines maintaining an ambient temperature of 35 C requires an airflow of 49-255 CMV. Thus when compared to the available airflow of 53 CFM, BMC 340 selects a 35 C operating temperature for sled 310.

It has been understood by the inventors of the current embodiments that sleds in a chassis may include a large number of storage devices, which are typically located upstream in the airflow in the sleds from the CPUs and DIMMs. Thus the airflow to the CPUs and DIMMs is effectively pre-heated, and the airflow needs of sled in order to maintain a selected ambient temperature is typically higher than the specified airflow ranges as provided in the TCT. As such, a condition may occur where the analysis as describe above, and the resulting selection of an ambient temperature based upon the available airflow, may result in a mismatch between the available airflow and the actual airflow needed to maintain the selected ambient temperature, thus leading to overtemperature conditions in the associated sleds.

In another embodiment, a hybrid is provided of the static definition of sled impedances (worst case mixing), and the dynamic definition of the maximum airflow available to each sled and the resulting selection of the maximum ambient temperature in in each of sleds 310-324. In particular, during a design phase of sleds 310-324, the thermal characteristics of the sleds can be determined based upon a configuration of the particular sleds, and a table can be derived to define the thermal settings for the sleds, as needed or desired. For example, a thermal setting table can be derived that identifies various sled configurations based upon the CPU TDP, an associated count of such CPUs in the sled, a DIMM size in the sled and the type of DIMMs, a backplane slot count, a storage drive count and drive type, and other elements, as needed or desired. A simplified thermal table is illustrated in Table 1, below:

TABLE 1
Thermal Characteristics Table

| | | | | Backplane | Drive | Drive | |
|---|---|---|---|---|---|---|---|
| Config No. | CPU TDP | DIMM Size | DIMM Type | Slot Count | Count | Type | Max Ambient |
| 1 | 265 | N/A | Any | 6 | Any | Any | Calculated |
| 2 | 265 | N/A | Any | 4 | Any | Any | 35 |
| 3 | 250 | N/A | Any | 6 | Any | Any | Calculated |
| 4 | 250 | N/A | Any | 4 | Any | Any | 35 |
| 5 | N/A | 32 GB | Any | Any | Any | Any | 45 |
| 6 | N/A | 64 GB | Any | Any | Any | Any | 45 |
| 7 | N/A | 256 GB | LRDIMM, RDIMM | 6 | Any | Any | Calculated |
| 8 | N/A | 256 GB | LRDIMM, RDIMM | 4 | Any | Any | 35 |
| 9 | N/A | 128 GB | Persistent | 6 | Any | Any | Calculated |
| 10 | N/A | 256 GB | Persistent | 4 | Any | Any | 35 |

As shown in configurations 1-4, in the configurations that include high-power CPUs (that is CPUs with TDPs of 265 W or 250 W) the CPU power dominates the maximum ambient temperature output, because the size and type of DIMMs, and the drive count and drive type are not probative of the resulting maximum ambient temperature. However, the backplane slot count dominates the determination of the maximum ambient temperature. In particular, configurations with six (6) count backplanes (configurations 1 and 3) necessitate the use of the dynamic determination of the maximum ambient temperature for the associated sleds, as described above, while the configurations with four (4) count backplanes (configurations 2 and 4) utilize the static determination of the maximum ambient temperature for the associated sleds, as described above. Similarly in the configurations 7-10 that include large memory devices (that is 128 GB and 256 GB DIMMs), the DIMM power dominates the maximum ambient temperature output, because the CPU TDP is not probative of the resulting maximum ambient temperature. Again, the backplane slot count dominates the determination of the maximum ambient temperature. In particular configurations with six (6) count backplanes (configurations 7 and 9) necessitate the use of the dynamic determination of the maximum ambient temperature for the associated sleds, while the configurations with four (4) count backplanes (configurations 8 and 10) utilize the static determination of the maximum ambient temperature for the associated sleds.

Configurations 1, 3, 7, and 9 that necessitate the use of the dynamic determination of the maximum ambient temperature are all configurations that would be disallowed configurations under the use of only static determinations. Thus the use of the dynamic determinations permits a wider range of system configurations to be produced by the manufacturer of information handling systems. A thermal characteristics table similar to Table 1 will include a large number of entries associated with the range of available option for populating sleds 310-324. Further, the choice of DIMM type, drive count, and drive type may result in a far more diverse set of thermal characteristics for the associated sled configurations. For example, from a strict perspective of the impedance of a particular sled configuration, a first sled with a less efficient backplane design but with no drives installed may exhibit a similar impedance to a second sled with a more efficient backplane but with drives installed. In this case the second sled would likely provide an airflow to the CPUs and DIMMs that is pre-heated, making the dynamic determination of the maximum ambient temperature skew to a higher ambient temperature than may be advisable. It is for such considerations that the hybrid of the static determination and the dynamic determination provides a meaningful solution. In particular, the second sled can be assigned a static value in the thermal characteristics table, with a lower maximum ambient temperature to account for the pre-heated airflow of the second sled configuration.

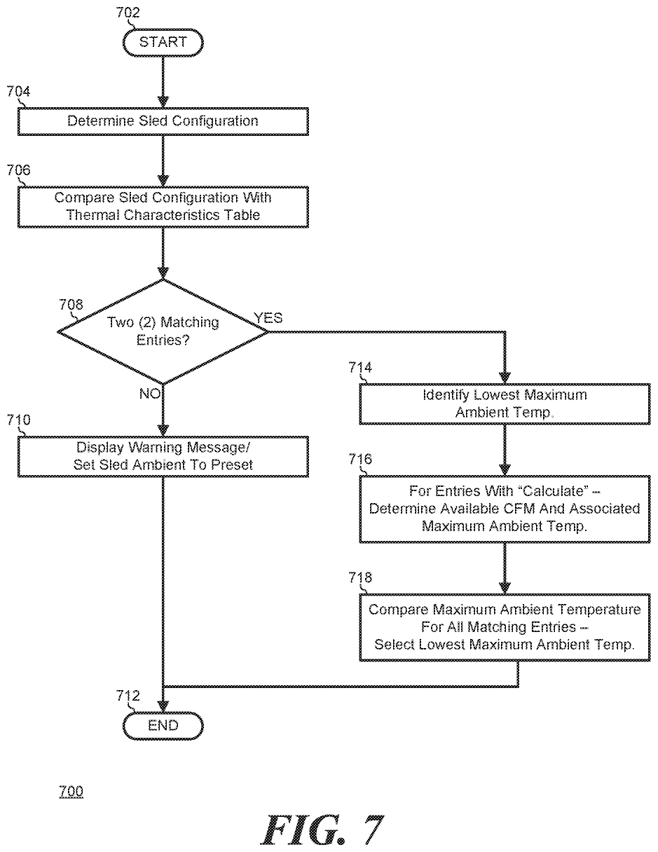

FIG. 7 illustrates a method 700 for a hybrid of statically and dynamically defined maximum supported ambient temperature in an information handling system starting at block 702. A configuration for a particular sled in a chassis is determined in block 704. For example, a sled configuration can be characterized in terms of CPU TDP, an associated count of such CPUs in the sled, a DIMM size in the sled and the type of DIMMs, a backplane slot count, a storage drive count and drive type, and other elements, as needed or desired. The sled configuration is compared with the entries of a thermal characteristics table such as Table 1 in block 706. A decision is made as to whether or not there are two or more matching entries in the thermal characteristics table in decision block 708.

If not, the “NO” branch of decision block 708 is taken, a warning message is provided that the sled maximum ambient temperature was not optimized and the sled maximum ambient temperature is set to a preset maximum, such as 25 C) in block 710, and the method ends in block 712. If there are two or more matching entries in the thermal characteristics table, the “YES” branch of decision block 708 is taken and a lowest of the maximum ambient temperatures from the multiple entries is determined in block 714. If any of the multiple entries indicate that the maximum ambient temperature is to be calculated, the available airflow is determined and the associated maximum ambient temperature is determined as described above in block 716. The selected maximum ambient temperature and the calculated maximum ambient temperature are compared for all matching entries and the lowest maximum ambient temperature is selected in block 718, and the method ends in block 712.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a chassis having an embedded controller configured to store a sled thermal characteristics table; and
a plurality of sleds, each sled having a baseboard management controller (BMC), wherein each BMC is configured to 1) determine a configuration of the associated sled, 2) match the configuration to a first entry of the sled thermal characteristics table, 3) determine whether a first maximum ambient temperature field of the first entry has a first maximum ambient temperature value or a first indication to calculate a second maximum ambient temperature value, 4) when the maximum ambient temperature field has the first maximum ambient temperature value, ascribe the first maximum ambient temperature value to the operation of the associated sled, and 5) when the maximum ambient temperature field has the first indication, to a) receive an available airflow value from the embedded controller, b) determine the second maximum ambient temperature value based upon the available airflow, and c) ascribe the second maximum ambient temperature value to the operation of the associated sled.

2. The information handling system of claim 1, wherein each BMC is further configured to 1) match the configuration to a second entry of the sled thermal characteristics table, 2) determine that a second maximum ambient temperature field of the second entry has a third maximum ambient temperature value, 3) determine that the third maximum ambient temperature value is lower than both the first and second maximum ambient temperature values, and 4) ascribe the third maximum ambient temperature value to the operation of the associated sled.

3. The information handling system of claim 1, wherein each BMC is further configured to 1) match the configuration to a second entry of the sled thermal characteristics table, 2) determine that a second maximum ambient temperature field of the second entry has a second indication to calculate a third maximum ambient temperature value, 3) determine the third maximum ambient temperature value based upon the available airflow, 4) determine that the third maximum ambient temperature value is lower than both the first and second maximum ambient temperature values, and 5) ascribe the third maximum ambient temperature value to the operation of the associated sled.

4. The information handling system of claim 1, wherein the first maximum ambient temperature value is based upon a worst case mixing of sleds in the chassis.

5. The information handling system of claim 4, wherein the available airflow for each sled is determined based upon an airflow impedance for each sled.

6. The information handling system of claim 5, wherein the airflow impedance for each sled is based upon the configuration of the associated sled.

7. The information handling system of claim 6, wherein the configuration of each sled includes a processor thermal design power (TDP) for the processors installed in the associated sled.

8. The information handling system of claim 7, wherein the configuration of each sled further includes a memory type for dual in-line memory modules (DIMMs) installed in the associated sled.

9. The information handling system of claim 8, wherein the configuration of each sled further includes a number of processors installed in the associated sled and a DIMM size of the DIMMs installed in the associated sled.

10. The information handling system of claim 9, wherein the configuration of each sled further includes a backplane slot count, a storage drive count, and a storage drive type.

11. A method, comprising:
providing, in an information handling system, a chassis having an embedded controller configured to store a sled thermal characteristics table;
providing, in the information handling system, a plurality of sleds, each sled having a baseboard management controller (BMC); and
for each BMC;
determining a configuration of the associated sled;
matching the configuration to a first entry of the sled thermal characteristics table;
determining whether a first maximum ambient temperature field of the first entry has a first maximum ambient temperature value or a first indication to calculate a second maximum ambient temperature value;
when the maximum ambient temperature field has the first maximum ambient temperature value, ascribing the first maximum ambient temperature value to the operation of the associated sled; and
when the maximum ambient temperature field has the first indication:
receiving an available airflow value from the embedded controller;
determining the second maximum ambient temperature value based upon the available airflow; and
ascribing the second maximum ambient temperature value to the operation of the associated sled.

12. The method of claim 11, wherein, for each BMC, the method further comprises:
matching the configuration to a second entry of the sled thermal characteristics table;
determining that a second maximum ambient temperature field of the second entry has a third maximum ambient temperature value;
determining that the third maximum ambient temperature value is lower than both the first and second maximum ambient temperature values; and
ascribing the third maximum ambient temperature value to the operation of the associated sled.

13. The method of claim 11, wherein, for each BMC, the method further comprises:
matching the configuration to a second entry of the sled thermal characteristics table;
determining that a second maximum ambient temperature field of the second entry has a second indication to calculate a third maximum ambient temperature value;
determining the third maximum ambient temperature value based upon the available airflow;
determining that the third maximum ambient temperature value is lower than both the first and second maximum ambient temperature values; and
ascribing the third maximum ambient temperature value to the operation of the associated sled.

14. The method of claim 11, wherein the first maximum ambient temperature value is based upon a worst case mixing of sleds in the chassis.

15. The method of claim 14, wherein the available airflow for each sled is determined based upon an airflow impedance for each sled.

16. The method of claim 15, wherein the airflow impedance for each sled is based upon the configuration of the associated sled.

17. The method of claim 16, wherein the configuration of each sled includes a processor thermal design power (TDP) for the processors installed in the associated sled.

18. The method of claim 17, wherein the configuration of each sled further includes a memory type for dual in-line memory modules (DIMMs) installed in the associated sled.

19. The method of claim 18, wherein the configuration of each sled further includes a number of processors installed in the associated sled, a DIMM size of the DIMMs installed in the associated sled, a backplane slot count, a storage drive count, and a storage drive type.

20. An information handling system, comprising:
a chassis having an embedded controller configured to store a sled thermal characteristics table including a plurality of entries, each entry associated with a sled configuration, each entry including a maximum ambient temperature field; and
a plurality of sleds, each sled having a baseboard management controller (BMC), wherein each BMC is configured to 1) determine a configuration of the associated sled, 2) match the configuration to a first entry of the sled thermal characteristics table, 3) determine whether a first maximum ambient temperature field of the first entry has a first maximum ambient temperature value or a first indication to calculate a second maximum ambient temperature value, 4) when the maximum ambient temperature field has the maximum ambient temperature value, ascribe the first maximum ambient temperature value to the operation of the associated sled, and 5) when the maximum ambient temperature field has the first indication, to a) receive an available airflow value from the embedded controller, b) determine the second maximum ambient temperature value based upon the available airflow, and c) ascribe the second maximum ambient temperature value to the operation of the associated sled.
